(19) United States
(12) Patent Application Publication
(10) Pub. No.: US 2026/0360330 A1
(43) Pub. Date: Nov. 12, 2026

(54) SOURCE DRIVING CHIP, DISPLAY PANEL, AND DRIVING METHOD OF DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventor: Weifeng CHEN, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 19/117,077

(22) PCT Filed: Nov. 1, 2024
(86) PCT No.: PCT/CN2024/129453

§ 371 Date: Mar. 30, 2025

(30) Foreign Application Priority Data
Nov. 30, 2023 (CN) 202311641869.X

(51) Int. Cl. G09G 3/36

(52) U.S. Cl. CPC G09G 3/3688; G09G 2310/0291

(57) ABSTRACT

A source driving chip, a display panel, and a driving method of the display panel are provided by the present disclosure. A first data configured to generate a first latch signal is generated according to a first to-be-counted signal in a first mode. A second data configured to generate a second latch signal is generated according to a second to-be-counted signal in a second mode. An end moment of each of two latch signals is configured to control latching of an initial data signal. An end moment of a delay sub-signal of the second latch signal is earlier than an end moment of a delay sub-signal of the first latch signal.

This application claims priority to and the benefit of Chinese Patent Application No. 202311641869.X, filed on Nov. 30, 2023. The entire disclosure of the aforementioned application is incorporated herein by reference in its entirety.

### TECHNICAL FIELD

The present disclosure relates to a technical field of display, and in particular to a source driving chip, a display panel, and a driving method of the display panel.

### BACKGROUND

Liquid crystal displays, which are widely used displays at present, have introduced an architecture of Data Line Sharing (DLS, where left and right adjacent sub-pixels share one data line) and a Tri-gate architecture (where gate lines are increased by 3 times to realize that the data lines are reduced to ⅓), considering cost of data driving chips at present.

Compared to an architecture of one gate line and one data line (1G1D), a number of source driving chips is reduced by half or more through the above architectures. However, due to differences in distances between a main board and different source driving chips, as well as differences in distances between each of the source driving chips and the data lines at different positions, parameters of the source driving chips at different positions need to be set differentially, so as to reduce differences in charging period of corresponding data signals acting on corresponding sub-pixels caused by the “differences in distances” mentioned above. However, at present, a range of the minimum order for the parameters of the source driving chips is relatively large, i.e., 9UI (where UI is a minimum unit of delay). For two source driving chips corresponding to a small “difference in distances” mentioned above, e.g., corresponding to two adjacent display regions, since a small output “difference in moments” is not possible to be set for the two source driving chips, the difference in moments arriving at two corresponding display regions of the data signals respectively output by the two source driving chips is too large, thereby occurring a split-screen phenomenon and reducing quality of display images.

### SUMMARY

An object of the present disclosure is to provide a source driving chip, a display panel, and a driving method of the display panel, so as to improve a split-screen phenomenon caused by a large minimum gear of parameters within the source driving chip in the existing display panel.

In a first aspect, a source driving chip is provided by the present disclosure. The source driving chip has a first mode and a second mode. The source driving chip further includes:
a counting module configured to generate a first data according to a first to-be-counted signal in the first mode and generate a second data according to a second to-be-counted signal in the second mode; and
a latch signal generating module electrically connected to the counting module, where the latch signal generating module is configured to generate a first latch signal according to the first data in the first mode and generate a second latch signal according to the second data in the second mode.

The first latch signal includes a first delay sub-signal. The second latch signal includes a second delay sub-signal. An end moment of the first delay sub-signal in the first latch signal is configured to control latching of an initial data signal. An end moment of the second delay sub-signal in the second latch signal is configured to control latching of the initial data signal. The end moment of the second delay sub-signal is earlier than the end moment of the first delay sub-signal.

In a second aspect, a display panel is further provided by the present disclosure. The display panel includes a panel body and a driving chip electrically connected to the panel body. The driving chip includes:
at least two source driving chips mentioned above, where each of the source driving chips is configured to generate a target data signal according to the initial data signal and transmit the target data signal to the panel body; and
a timing control chip electrically connected to the source driving chips, where the timing control chip is configured to control each of the source driving chips to generate the first latch signal in the first mode, and configured to control each of the source driving chips to generate the second latch signal in the second mode.

In a third aspect, a driving method of a display panel is further provided by the present disclosure. The driving method is configured to drive the display panel mentioned above. The driving method includes steps of:
generating the first latch signal in the first mode, the first latch signal including the first delay sub-signal, the end moment of the first delay sub-signal in the first latch signal being configured to control latching of the initial data signal, and the initial data signal being latched according to the first latch signal; and
generating the second latch signal in the second mode, the second latch signal including the second delay sub-signal, the end moment of the second delay sub-signal in the second latch signal being configured to control latching of the initial data signal, and the initial data signal being latched according to the second latch signal.

The step of generating the first latch signal in the first mode includes:
generating the first data according to the first to-be-counted signal in the first mode; and
generating the first latch signal according to the first data.

The step of generating the second latch signal in the first mode includes:
generating the second data according to the second to-be-counted signal in the second mode; and
generating the second latch signal according to the second data.

### BRIEF DESCRIPTION OF THE DRAWINGS

FIG. 1, FIG. 3, FIG. 7, and FIG. 8 are a plurality of structural block diagrams of a source driving chip according to the embodiments of the present disclosure, respectively.

FIG. 2, FIG. 4, FIG. 5, and FIG. 6 are waveform diagrams of some signals in the display panel according to the embodiments of the present disclosure, respectively.

FIG. 9 and FIG. 10 are two flowcharts of a driving method of the display panel according to the embodiments of the present disclosure, respectively.

FIG. 11 is a circuit diagram of a first delay sub-unit according to the embodiments of the present disclosure.

FIG. 12 is a circuit diagram of a first exclusive-OR sub-unit according to the embodiments of the present disclosure.

### DETAILED DESCRIPTION

The technical solutions in the embodiments of the present disclosure will be described clearly and completely hereafter with reference to accompanying drawings of the embodiments of the present disclosure. Apparently, the described embodiments are merely a part of the embodiments of the present disclosure, rather than all of the embodiments of the present disclosure. Based on the embodiments of the present disclosure, all other embodiments obtained by a person of ordinary skill in the art without creative efforts shall fall within a protection scope of the present disclosure.

In description of the present disclosure, terms such as “first” and “second” are used herein for purposes of description, and should not be interpreted as indication or implication of relative importance, or implied indication of a number of the technical features. Therefore, features limited by terms such as “first” and “second” can explicitly or impliedly include one or more than one of these features. In addition, it should be further noted that the drawings merely provide structures closely related to inventive points of the present disclosure. Some details not related to the inventive points are omitted, so as to simplify the drawings and make the inventive points clear at a glance. Instead of indicating that the actual device is exactly the same as the drawings, and the drawings are not intended to be a limitation of the actual device.

Reference herein to “embodiments” means that particular features, structures, or characteristics described in connection with the embodiments may be included in at least one embodiment of the present disclosure. The occurrence of this phrase at various locations in time in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

Beneficial effects are illustrated below. A source driving chip, a display panel, and a driving method of the display panel are provided by the present disclosure. The source driving chip has a first mode and a second mode. The source driving chip is configured to generate a first data according to a first to-be-counted signal in the first mode and generate a first latch signal according to the first data. The source driving chip is further configured to generate a second data according to a second to-be-counted signal in the second mode and generate a second latch signal according to the second data. The first latch signal includes a first delay sub-signal. The second latch signal includes a second delay sub-signal. An end moment of the first delay sub-signal in the first latch signal is configured to control latching of an initial data signal. An end moment of the second delay sub-signal in the second latch signal is configured to control latching of the initial data signal. By setting that the end moment of the second delay sub-signal is earlier than the end moment of the first delay sub-signal, “ranges of the minimum orders” in two modes are different. For two source driving chips corresponding to a small “difference in distance”, the two source driving chips may be provided to operate in the second mode, so that a difference between end moments of delay sub-signals of the two source driving chips is small, and thus a difference between moments two corresponding target data signals are outputted to a plurality of sub-pixels corresponding to the two target data signals is small, thereby reducing risk of a split-screen phenomenon.

A source driving chip is provided by the present disclosure. The source driving chip may include, but is not limited to, the following embodiments and combinations of the following embodiments.

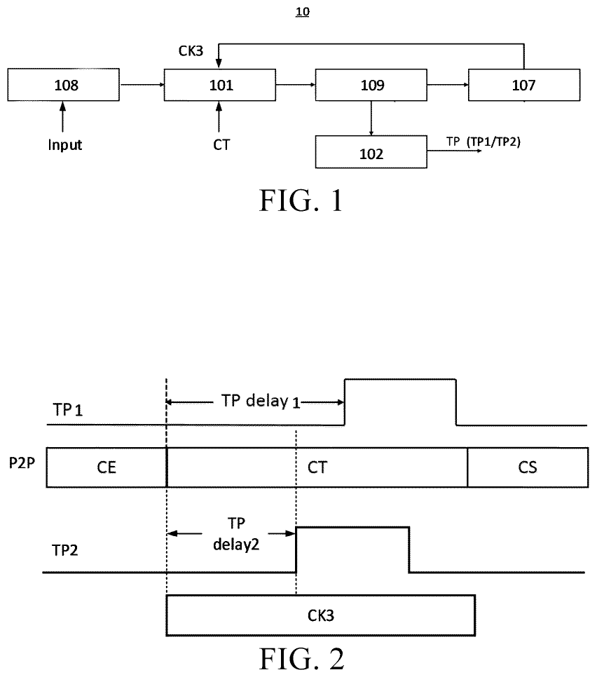

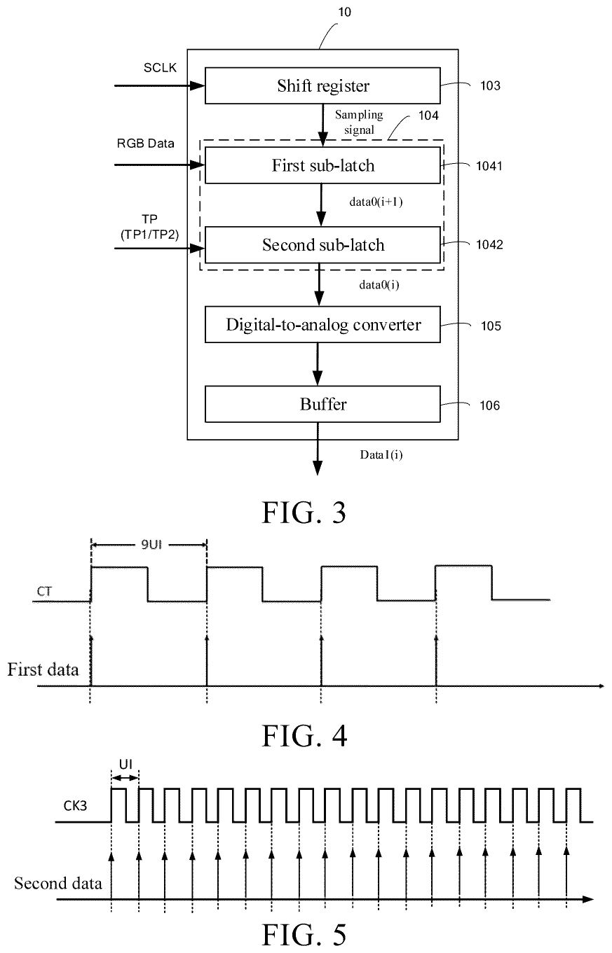

In one embodiment, as shown in FIG. 1 and FIG. 2, a source driving chip 10 has a first mode M1 and a second mode M2. The source driving chip 10 includes a counting module 101 and a latch signal generating module 102. The counting module 101 is configured to generate a first data according to a first to-be-counted signal CT in the first mode M1 and generate a second data according to a second to-be-counted signal CK3 in the second mode M2. The latch signal generating module 102 is electrically connected to the counting module 101. The latch signal generating module 102 is configured to generate a first latch signal TP1 according to the first data in the first mode MI and generate a second latch signal TP2 according to the second data in the second mode M2. As shown in FIG. 2, the first latch signal TP1 includes a first delay sub-signal (with a duration of “TP delay1”). The second latch signal TP2 includes a second delay sub-signal (with a duration of “TP delay2”). An end moment of the first delay sub-signal in the first latch signal TP1 is configured to control latching of an initial data signal data0. An end moment of the second delay sub-signal in the second latch signal TP2 is configured to control latching of the initial data signal data0. The end moment of the second delay sub-signal is earlier than the end moment of the first delay sub-signal.

Specifically, as shown in FIG. 3, the source driving chip 10 may further include a shift register 103, a latch 104, a digital-to-analog converter 105, and a buffer 106. The shift register 103 is loaded with a source sampling clock signal SCLK. The latch 104 (including a first latch 1041 or a second latch 1042) is loaded with a corresponding image signal RGB Data and a corresponding latch signal TP (the first latch signal TP1 or the second latch signal TP2). The shift register 103 may generate a sampling signal inputted to the first latch 1041 based on the source sampling clock signal SCLK. The first latch 1041 may sample the corresponding image signal RGB Data according to the sampling signal to acquire a plurality of initial data voltages (included in a corresponding initial data signal data0) corresponding to a plurality of sub-pixels located in a same row. The plurality of initial data voltages are sequentially transmitted to the digital-to-analog converter 105 after being latched by the first latch 1041 and another sub-latch. The digital-to-analog converter 105 can convert the plurality of data voltages (essentially digital voltages) in the initial data signal data0 into analog data voltages based on a gamma reference voltage. Moreover, the buffer may amplify the analog data voltages to acquire a plurality of target data voltages (constituting a target data signal data1) loaded to the corresponding plurality of sub-pixels.

It should be noted that the initial data signal corresponding to the plurality of sub-pixels at each stage sequentially passes through the first latch 1041 and the second latch 1042 to be transmitted to the digital-to-analog converter 105. Such as, the source driving chip 10 being processing an initial data signal data0(i) corresponding to a plurality of sub-pixels at an i-th stage is taken as an example to explain herein. The first latch 1041 may be configured to latch an initial data signal data0(i+1). The initial data signal data0(i+1) includes a plurality of initial data voltages corresponding to a plurality of sub-pixels at an (i+1)-th stage. The second latch 1042 may be configured to latch the initial data signal data0(i). The initial data signal data0(i) includes a plurality of data voltages corresponding to the plurality of sub-pixels at the i-th stage before the (i+1)-th stage. Moreover, the plurality of initial data voltages in the initial data signal data0(i) outputted from the second latch 1042 are sequentially processed by the corresponding digital-to-analog converter 105 and the buffer 106, so as to generate the plurality of target data voltages loaded to the corresponding plurality of sub-pixels.

The second latch 1042 may control a moment when the initial data signal data0 enters the second latch 1042 and a moment when the initial data signal data0 leaves the second latch 1042, under control of the latch signal. Specifically, as shown in FIG. 2, the source driving chip 10 may further receive a P2P signal to generate the corresponding latch signal according to the P2P signal. For example, the P2P signal may include a row end sub-signal CE, a to-be-counted signal (the first to-be-counted signal CT or the second to-be-counted signal CK3), and a row start sub-signal CS arranged in sequence. It may be considered that the source driving chip 10, upon recognizing the to-be-counted signal following the row end sub-signal CE, can start generating the latch signal. In other words, a start moment of the latch signal is the same as a start moment of the to-be-counted signal, and a specific waveform of the latch signal can be determined at least by a specific waveform of the to-be-counted signal. Each latch signal (the first latch signal TP1 or the second latch signal TP2) may include a delay sub-signal (the first delay sub-signal included in the first latch signal TP1 or the second delay sub-signal included in the second latch signal TP2) and a latch sub-signal (a first latch sub-signal located after the first delay sub-signal or a second latch sub-signal located after the second delay sub-signal) arranged in sequence. The end moment of the delay sub-signal may be equal to a start moment of the corresponding latch sub-signal. Taking the initial data signal data0(i) at the i-th stage as an example, it may be considered that the initial data signal data0 is inputted to the second latch 1042 at the start moment of the latch sub-signal (e.g., the end moment of the corresponding first delay sub-signal or the second delay sub-signal, i.e., an end moment of “TP delay1” or “TP delay2”), and the second latch 1042 outputs the initial data signal data0 at the end moment of the latch sub-signal.

In the present disclosure, an amplitude of the delay sub-signal in each latch signal being less than an amplitude of the corresponding latch sub-signal is taken as an example to illustrate. It may be considered that the latch signal is at a rising edge at the end moment of the delay sub-signal (i.e., the start moment of the latch sub-signal).

In other words, for source driving chips 10 located at different positions, under a condition that the start moment of the delay sub-signal and the duration period of the latch sub-signal are constant, the end moment of the delay sub-signal or the duration period of the delay sub-signal are set differentially. Thus different output moments of the corresponding initial data signal data0 can be realized to compensate for differences in charging period caused by differences in distances between different source driving chips 10 and the plurality of sub-pixels, so that output moments of the corresponding target data signal datal to the corresponding plurality of sub-pixels is the same. The duration period of the delay sub-signal in each source driving chip 10 is incremented based on the “range of the minimum order”. In other words, the end moment of the delay sub-signal is delayed with a base value of the “range of the minimum order”. In other words, the difference between the duration periods of the two delay sub-signals in the two latch signals corresponding to any two source driving chips 10 may be equal to an integer multiple of the “range of the minimum order”.

It should be noted that for the two source driving chips 10 corresponding to the small “difference in distance” mentioned above, the current range of the minimum order is relatively large and is 9UI (where UI is a minimum unit of delay). For the two source driving chips 10 corresponding to the small “difference in distance” mentioned above, e.g., corresponding to two adjacent display regions, since a small output “difference in moment” (the difference value is at least 9UI) is not possible to be set for the two source driving chips, a difference in moments arriving at two corresponding display regions of the data signals respectively output by the two source driving chips is too large, thereby occurring a split-screen phenomenon and reducing quality of display images.

The first mode M1 and the second mode M2 mentioned above are merely used to represent two modes in which the source driving chip 10 generates the first latch signal and the second latch signal, respectively, and merely for conceptual illustration. Certainly, it can be determined from other signals, when the source driving chip 10 generates the first latch signal and when the source driving chip 10 generates the second latch signal, i.e., when the driving chip is in the first mode M1 and when the driving chip is in the second mode M2, which will be discussed later.

It may be understood that the source driving chip 10 in this embodiment may have at least two operating modes including the first mode M1 and the second mode M2. The moments for controlling latching of the corresponding initial data signal (the end moment of the delay sub-signal in the two latch signals) generated in the two modes are different, i.e., the “ranges of the minimum orders” mentioned above are different. For the two source driving chips 10 corresponding to the small “difference in distance”, they may be set to operate in the second mode M2, the difference between the end moments of the delay sub-signals in the two latch signals is small. Thus the difference in moments when the corresponding two target data signals datal are outputted to the corresponding plurality of sub-pixels is small, thereby reducing the risk of split-screen phenomenon. Certainly, the two source driving chips 10 corresponding to a large “difference in distance” may be set to operate in the first mode M1 to compensate for the large difference in charging period between the respective sub-pixels caused by the large “difference in distance”.

In one embodiment, as shown in FIG. 4 and FIG. 5, the first to-be-counted signal CT and the second to-be-counted signal CK3 are both periodic signals. A period of the second to-be-counted signal CK3 is smaller than a period of the first to-be-counted signal CT.

Specifically, as shown in FIG. 2, FIG. 4, and FIG. 5, as discussed above, the start moment of the delay sub-signal in the latch signal is equal to the start moment of the to-be-counted signal. The duration period of the delay sub-signal in the latch signal can be determined at least according to the to-be-counted signal. Taking the to-be-counted signal (the first to-be-counted signal CT and the second to-be-counted signal CK3) being a periodic and square wave signal as an example to illustrate, the counting module 101 may count once at each rising edge of the to-be-counted signal. At any point in time, a number of times currently counted can be set as the data (first data or second data) at the current moment, i.e., the data is related to both the duration period of the counting and the period of the to-be-counted signal. At any point in time, a value of the corresponding latch signal at this point in time can be determined according to a magnitude relationship between a specific value of the current data and a preset value.

As shown in FIG. 2 and FIG. 4, for example, the first to-be-counted signal CT is a square wave signal with the period equal to 9UI (1UI can be understood as a unit interval). The counting module 101 may count once at each rising edge in the first signal CT. Taking a first rising edge as a starting point of counting, the first data is equal to 2 at the moment of “18UI” (a value of “first data” in FIG. 4 is equal to a number of arrows generated at the current moment and before, and each rising edge in the to-be-counted first signal CT generates one arrow). By extension, the first data is equal to n/9 at the moment of “n*UI”. If a first preset value is equal to x 1, since the first data is increasing from 0, it may be considered that when the first data is less than or equal to x1, a value corresponding to the first latch signal TP1 is controlled to be a first value (corresponding to the first delay sub-signal), and when the first data is greater than x1, the value corresponding to the first latch signal TP1 is controlled to be a second value (corresponding to the first latch sub-signal). For example, when the second value is greater than the first value, it is considered that when the first data changes from less than or equal to x1 to greater than x1, an upward hopping is generated in the first latch signal TP1.

As shown in FIG. 2 and FIG. 5, a difference lies in that the period of the second to-be-counted signal CK3 is equal to a UI, and the first data is equal to n at the moment of “n*UI”. If the second preset value is equal to x2, it may be considered that when a value corresponding to the second latch signal TP2 is controlled to be the first value (corresponding to the second delay sub-signal), and when the second data is greater than x2, the value corresponding to the second latch signal TP2 is controlled to be the second value (corresponding to the second latch sub-signal). For example, when the second value is greater than the first value, it is considered that when the second data changes from less than or equal to x1 to greater than x1, an upward hopping is generated in the second latch signal TP2.

It may be understood that in this embodiment, the period of the second to-be-counted signal CK3 is set to be smaller than the period of the first to-be-counted signal CT. In other words, a minimum value (i.e., the “range of the minimum order”) of the duration period of the second delay sub-signal in the second mode may be less than a minimum value (i.e., the “range of the minimum order”) of the duration period of the first delay sub-signal in the first mode, thereby achieving two different “ranges of the minimum orders” mentioned above.

In one embodiment, as shown in FIG. 1, the source driving chip 10 further includes a to-be-counted signal generating module 107 electrically connected to the counting module 101 and configured to generate the second to-be-counted signal CK3. As shown in FIG. 6, the to-be-counted signal generating module 107 is configured to generate the second to-be-counted signal CK3 according to an initial to-be-counted signal CK1 or the first to-be-counted signal CT. The initial to-be-counted signal CK1, the first to-be-counted signal CT, and the second to-be-counted signal CK3 are all periodic signals. A period of the initial to-be-counted signal CK1 is smaller than the period of the first to-be-counted signal CT.

Specifically, it may be considered that the first to-be-counted signal CT can be acquired by the source driving chip 10 from an external environment (including but not limited to a timing control chip) for the counting by the counting module 101. While the newly added second to-be-counted signal CK3 having a small period can be generated by the newly added to-be-counted signal generating module 107 for the counting by the counting module 101.

Specifically, the period of the first to-be-counted signal CT equal to 9 UI is taken as an example herein. If the period of the initial to-be-counted signal CK1 is greater than 9UI, the initial to-be-counted signal CK1 is not necessary to be set, and the second to-be-counted signal CK3 having a small period is directly acquired by successively raising frequency of the first to-be-counted signal CT. If the period of the initial to-be-counted signal CK1 is less than 9UI, for example, equal to 4UI as shown in FIG. 6, the second to-be-counted signal CK3 having a small period is acquired by successively raising frequency of the initial to-be-counted signal CK1. For example, the frequency of the initial to-be-counted signal CK1 is firstly raised to acquire the second transition signal CK11 having a period equal to 2UI, and then the frequency of the second transition signal CK11 is raised to acquire the CK3 having a period equal to UI.

Certainly, since the period of the initial to-be-counted signal CK1 is also smaller than the period of the first to-be-counted signal CT, the initial to-be-counted signal CK1 may be directly set as the second to-be-counted signal CK3 for the counting process by the counting module 101. As described above, when other conditions are consistent at this point in time, it is further possible to realize that the end moment of the second delay sub-signal is earlier than the end moment of the first delay sub-signal. Thus a smaller “range of the minimum order” in the second mode M2 can be realized to be applicable to the two source driving chips 10 corresponding to the smaller “difference in distance”.

In one embodiment, as shown in FIG. 7, the to-be-counted signal generating module 107 includes a first switching unit 1071, and the first switching unit 1071 and a raising-frequency unit 1072 electrically connected. The raising-frequency unit 1072 is electrically connected to the counting module 101. The first switching unit 1071 is configured to control the initial to-be-counted signal CK1 or the first to-be-counted signal CT to be transmitted to the raising-frequency unit 1072 according to a first switching signal in the second mode M2. The raising-frequency unit 1072 is configured to generate the second to-be-counted signal CK3 according to the initial to-be-counted signal CK1 or the first to-be-counted signal CT in the second mode M2. In this embodiment, source of the initial to-be-counted signal CK1 or the first to-be-counted signal CT to be acquired by the first switch unit 1071 is not limited. Source of the first switching control signal is not limited, i.e., a connection mode between the first switch unit 1071 and the external environment is not limited.

Specifically, the first switching unit 1071 may include a first switching transistor Q100. A gate of the first switching transistor Q100 may be loaded with a first switching signal. A source of the first switching transistor Q100 may be loaded with the initial to-be-counted signal CK1 or the first to-be-counted signal CT (only taking the initial to-be-counted signal CK1 being loaded as an example in FIG. 7). A drain of the first switching transistor Q100 may be electrically connected to the raising-frequency unit 1072. The first switching signal may be presented as an effective voltage in the second mode M2 to turn on the first switching transistor Q100. Thus the initial to-be-counted signal CK1 or the first to-be-counted signal CT is transmitted to the raising-frequency unit 1072 through the first switching transistor Q100, thereby the raising-frequency unit 1072 generates the second to-be-counted signal CK3 having a smaller period based on the initial to-be-counted signal CK1 or the first to-be-counted signal CT having a larger period and a smaller frequency.

In one embodiment, as shown in FIG. 6 and FIG. 7, the raising-frequency unit 1072 includes a first delay sub-unit 10721 and a first exclusive-OR sub-unit 10722. The first delay sub-unit 10721 is electrically connected to the first switching unit 1071. The first delay sub-unit 10721 is configured to generate a first transition signal CK2 according to a first control signal Ctrl1 and one of the initial to-be-counted signal CK1 and the first to-be-counted signal CT (taking the initial to-be-counted signal CK1 as an example) in the second mode M2. The first transition signal CK2 is a signal acquired by the first to-be-counted signal CT being delayed for a first preset period H1. The first preset period H1 is not equal to 0. The first exclusive-OR sub-unit 10722 is electrically connected to the first delay sub-unit 10721 and the first switching unit 1071. The first exclusive-OR sub-unit 10722 is configured to generate the second to-be-counted signal CK3 or a second transition signal CK11 according to the first transition signal CK2 and one of the initial to-be-counted signal CK1 and the first to-be-counted signal CT in the second mode M2 (taking the initial to-be-counted signal CK1 as an example herein). The second transition signal CK11 is configured to generate the second to-be-counted signal CK3. The second to-be-counted signal CK3 or the second transition signal CK11 generated by the first exclusive-OR module 10722 is a signal acquired by the first transition signal CK2 and one of the initial to-be-counted signal CK1 and the first to-be-counted signal CT being performed an exclusive-OR operation. A period of one of the second to-be-counted signal CK3 and the second transition signal CK11 generated by the first exclusive-OR sub-unit 10722 is half of a period of one of the initial to-be-counted signal CK1 and the first to-be-counted signal CT.

It may be understood that in this embodiment, the first delay sub-unit 10721 in the raising-frequency unit 1072 may perform a delay process on the received initial to-be-counted signal CK1 or the first to-be-counted signal CT (taking the initial to-be-counted signal CK1 as an example herein) under the action of the first control signal Ctrl1. For example, the initial to-be-counted signal CK1 having a period of 4UI may be delayed by 1UI to acquire the first transition signal CK2 having a period of 4UI. Moreover, the first exclusive-OR sub-unit 10722 in the raising-frequency unit 1072 may perform an exclusive-OR operation on the received initial to-be-counted signal CK1 and the first transition signal CK2 to acquire the second transition signal CK11 having a period of 2UI, thereby achieving a process for halving half of the period of the initial to-be-counted signal CK1.

Similarly, since a period of the second transition signal CK11 is also smaller than the period of the first to-be-counted signal CT, the second transition signal CK11 may be directly set as the second to-be-counted signal CK3 for the counting process by the counting module 101. As described above, when other conditions are consistent at this point in time, it is also possible to realize that the end moment of the second delay sub-signal is earlier than the end moment of the first delay sub-signal. Thus the smaller “range of the minimum order” in the second mode M2 is realized to be applicable for the two source driving chips 10 corresponding to the smaller “difference in distance”. Certainly, the frequency of the second transition signal CK11 may be further raised to acquire the second to-be-counted signal CK3 having a smaller period.

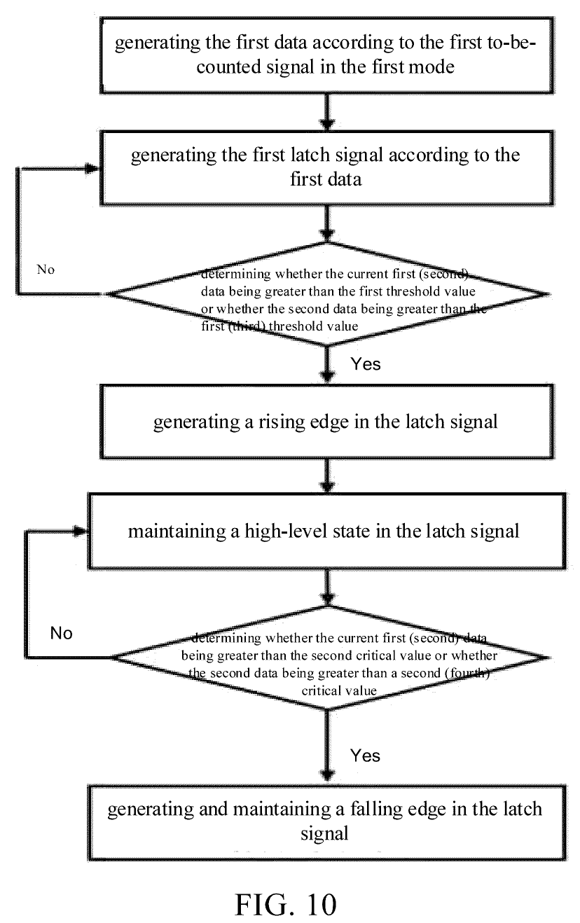

As shown in FIG. 7 in combination with FIG. 11, the first delay sub-unit 10721 may be a gated D latch. The first delay sub-unit 10721 may be, but is not limited to, a transmission gated D latch or a logic gated D latch. Taking the logic gated D latch as an example to illustrate herein, the first delay sub-unit 10721 may include a NOR gate G1, a NOR gate G2, an AND gate G3, an AND gate G4, and a NOT gate G5 electrically connected according to a connection relationship in FIG. 11. One input terminal of the AND gate G3 and one input terminal of the AND gate G4 can be respectively configured as a data input terminal D (which can load the initial to-be-counted signal CK1) and an enable terminal E (which can load the first control signal Ctrl1) of the logic gate D latch. The NOT gate G5 can be connected between the other input terminal of the AND gate G4 and the data input terminal D. It may be considered that G1, G2, G3, G4, and their connection relationships constitute an SR latch. An output terminal of the NOR gate G2 and an output terminal of the NOR gate G1 are configured as an output terminal Q of the logic gated D latch (which can output the first transition signal CK2) and a reverse output terminal Q, respectively. Since a circuit will be locked in a state determined by the initial to-be-counted signal CK1 instantly before a value of the first control signal Ctrl1 changes from 1 to 0, a state of the logic gate D latch can be remained unchanged when the value of the first control signal Ctrl1 is 0, thereby 1-bit binary data can be stored. Moreover, when the value of the first control signal Ctrl1 is 1, the first transition signal CK2 outputted by the output terminal Q can change following a state of the initial to-be-counted signal CK1 loaded by the data input terminal D. Therefore, the first transition signal CK2 can be acquired by delaying the initial to-count signal CK1 with a same waveform.

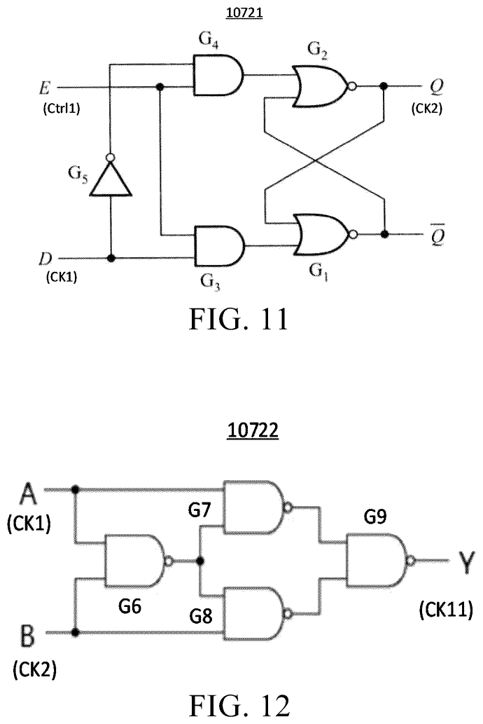

As shown in FIG. 7 in combination with FIG. 12, the first exclusive-OR sub-unit 10722 may be an exclusive-OR gate. The exclusive-OR gate may include a NOT gate G6, a NOT gate G7, a NOT gate G8, and a NOT gate G9 electrically connected according to a connection relationship in FIG. 12. Two input terminals of the NOT gate G6 are respectively configured as an input terminal A (which can load the initial to-be-counted signal CK 1) and an input terminal B (which can load the first transition signal CK2) of the exclusive-OR gate. An output terminal of the NOT gate G9 may be configured as an output terminal Y (which can output the second transition signal CK11) of the exclusive-OR gate. A characteristic of the exclusive-OR gate is that “same is 0, and different is 1”. That is to say, when a value of the initial to-be-counted signal CK1 and a value of the first transition signal CK2 are both 0 or 1, a value of the output second transition signal CK11 is 0. Instead, when one of the two values is 0 and the other one is 1, the value of the output second transition signal CK11 is 1.

In one embodiment, as shown in FIG. 6 in combination with FIG. 7, the first exclusive-OR sub-unit 10722 is configured to generate the second transition signal CK11. The raising-frequency unit 1072 further includes a second delay sub-unit 10723 and a second delay sub-unit 10724. The second delay sub-unit 10723 is electrically connected to the first exclusive-OR sub-unit 10722. The second delay sub-unit 10723 is configured to generate a third transition signal CK22 according to the second transition signal CK11 and a second control signal Ctrl2 in the second mode M2. The third transition signal CK22 is a signal acquired by the second transition signal CK11 being delayed for a second preset period H2. The second preset period H2 is not equal to 0. The second exclusive-OR sub-unit 10724 is electrically connected to the second delay sub-unit 10723 and the first exclusive-OR sub-unit 10722. The second exclusive-OR sub-unit 10724 is configured to generate the second to-be-counted signal CK3 according to the third transition signal CK22 and the second transition signal CK 11. The second to-be-counted signal CK3 generated by the exclusive-OR module is a signal acquired by the third transition signal CK22 and the second transition signal CK 11 being performed an exclusive-OR operation. A period of the second to-be-counted signal CK3 generated by the second exclusive-OR sub-unit 10724 is half of a period of the second transition signal CK11.

It should be understood that in this embodiment, the second delay sub-unit 10723 and the second exclusive-OR sub-unit 10724 are further provided in the raising-frequency unit 1072. The second delay sub-unit 10723 may perform a delaying process on the received second transition signal CK11 under the action of the second control signal Ctrl2. For example, the second transition signal CK11 having the period of 2UI may be delayed by (½)UI to acquire the third transition signal CK22 still having the period of 2UI. Moreover, the second exclusive-OR sub-unit 10724 may perform an exclusive-OR operation on the received third transition signal CK22 and the second transition signal CK 11 to acquire the second to-be-counted signal CK3 having a period of 1UI, thereby reducing the period of the initial to-be-counted signal CK1 to ¼of the original period.

In such case, the period of the second to-be-counted signal CK3 can be further reduced to achieve a smaller “range of the minimum order” in the second mode M2, thereby being applicable to the two source driving chips 10 corresponding to a smaller “difference in distance”.

The second delay sub-unit 10723 may also be a gated D latch, which can be understood with reference to the above description of the first delay sub-unit 10721. The second transition signal CK11, the second control signal Ctrl2, and the third transition signal CK22 can be understood in analogy with the initial to-be-counted signal CK1, the first control signal Ctrl1, and the first transition signal CK2, respectively.

Similarly, the second exclusive-OR sub-unit 10724 may also be an exclusive-OR gate, which can be understood with reference to the above description of the first exclusive-OR sub-unit 10722. The second transition signal CK 11, the third transition signal CK22, and the second to-be-counted signal CK3 can be understood in analogy with the first transition signal CK2, the initial to-be-counted signal CK1, and the second transition signal Ck11, respectively.

In one embodiment, as shown in FIG. 1, the source driving chip 10 further includes a selecting module 108 electrically connected to the counting module 101. The selecting module 108 is configured to, according to an input signal Input, control the counting module 101 to load the first to-be-counted signal CT to be in the first mode M1 or control the counting module 101 to load the second to-be-counted signal CK3 to be in the second mode M2. It may be understood that as discussed above, the counting module 101 may receive the first to-be-counted signal CT generated by the external environment (for example, but not limited to the timing control chip), and may also receive the second to-be-counted signal CK3 generated by the to-be-counted signal generating module 107. Moreover, by further providing the selecting module 108 in this embodiment, the counting module 101 may be controlled to load the first to-be-counted signal CT with a larger period or the second to-be-counted signal CK3 with a small period according to the input signal Input. The input signal Input may be set in advance according to the distances between on one side the source driving chip 10 and the previous source driving chip 10, and on the other side the plurality of sub-pixels), thereby realizing an appropriate “range of the minimum order”.

In combination with the above discussion, it can be seen that whether the source driving chip 10 at present should be in the first mode M1 or the second mode M2 can be set according to the current input signal Input. The input signal Input can be determined in advance according to debugging results of adjacent two source driving chips 10 in the display panel. For example, a distance between the adjacent two source driving chips 10 in the display panel is relatively small, i.e., an accuracy requirement of the “range of the minimum order” is relatively high. A specific value of the input signal Input at this moment may be set to make the selecting module 108 determine that the source driving chip 10 should be in the second mode M2. The specific value of the Input can be determined according to the previous debugging results (i.e., the split-screen phenomenon of the display panel can be eliminated).

The selecting module 108 may essentially include a comparator circuit or a switching circuit. If the selecting module 108 is a comparator, two input terminals of the comparator may be respectively loaded with the input signal Input and a reference signal. The comparator may output a corresponding signal according to a magnitude relationship between the input signal Input and the reference signal to control the counting module 101 to load the first to-be-counted signal CT or the second to-be-counted signal CK3. Similarly, if the selecting module 108 is selected as the switching circuit, an input terminal of the switching circuit is loaded with the input signal Input. An output terminal of the switching circuit can output a corresponding signal according to magnitude of the input signal Input to control the counting module 101 to load the first to-be-counted signal CT or the second to-be-counted signal CK3.

In one embodiment, as shown in FIG. 1 in combination with FIG. 7, the source driving chip 10 further includes a logic module 109 electrically connected between the counting module 101 and the latch signal generating module. The logic module 109 is configured to generate a first determination data according to the first data in the first mode M1and a second determination data according to the second data in the second mode M2. As shown in FIG. 8, the latch signal generating module includes a second switching unit 1021 electrically connected to the logic module. The second switching unit 1021 is configured to control the end moment of the first delay sub-signal in the first latch signal TP1 according to the first determination data in the first mode M1, and control the end moment of the second delay sub-signal in the second latch signal TP2 according to the second determination data in the second mode M2. The initial to-be-counted signal CK1 mentioned above may be generated by, but is not limited to, the logic module and transmitted to the first switching unit 1071.

Moreover, the input signal Input mentioned above may be stored in a register (whether the register is integrated with the source driving chip 10 is not limited). The selecting module 108 may read the input signal Input in the register (the input signal Input may essentially be a value of the register, and the value may be 0 or 1). Moreover, the selecting module 108 may also be integrated within the logic module 109.

It should be noted that the source driving chip 10 may be in the first mode M1 or the second mode M2 at each moment. In the two modes, the counting module 101 generates the first data and the second data, respectively. Therefore, it may be considered that a data received by the logic module at each moment may be one of the first data and the second data, so as to generate a corresponding first determination data or a corresponding second determination data. Thus the first determination data or the second determination data is applied to the second switching unit to control the end moment of the first delay sub-signal in the first latch signal TP1 or the end moment of the second delay sub-signal in the second latch signal TP2. Moreover, in combination with other conditions discussed above, the complete first latch signal TP1 and the second latch signal TP2 are generated respectively.

Specifically, the second switching unit may include a second switching transistor Q1. A gate of the second switching transistor is electrically connected to the logic module. A source of the second switching transistor is loaded with an operating voltage VDD. A drain of the second switching transistor is electrically connected to a resistor R and is configured to output the latch signal TP. Taking the first mode M1 as an example to illustrate, the logic module can compare the first data with a preset first critical value at each moment. If the first data is less than or equal to the first critical value, the first determination data may be considered to be equal to the first value for controlling the second switching transistor to be turned off. In such case, the latch signal TP is maintained as an original value. If the first data is greater than the first threshold value, the first determination data can be considered to be equal to the second value for controlling the second switching transistor to be turned off. In such case, the latch signal TP can be changed from the original value to be equal to an operating voltage VDD (this moment also represents the end moment of the first delay sub-signal). It may be understood that as time goes by, the first data will gradually increase. When the first data is greater than a second critical value (greater than the first critical value), it can be considered that the first determination data is again equal to the first value used for controlling the second switching transistor to be turned off, i.e., this moment represents the end moment of the first latch sub-signal.

It should be noted that modules or devices such as the counting module, the latch signal generating module, the shift register, the first latch, the second latch, the digital-to-analog converter, the buffer, the to-be-counted signal generating module, the selecting module, and the logic module mentioned in the present disclosure may be substantially composed of at least one component, e.g., including at least one of a transistor, a capacitor, and a resistor, and wires electrically connected between different components. A specific composition can refer to the discussion above.

The present disclosure further includes a display panel. The display panel includes a panel body and a driving chip electrically connected to the panel body. The driving chip includes at least two source driving chips 10 as discussed above and a timing control chip. Each of the source driving chips 10 is configured to generate a target data signal datal according to the initial data signal and transmit the target data signal datal to the panel body. The timing control chip is electrically connected to the source driving chips 10. The timing control chip is configured to control each of the source driving chips 10 to generate the first latch signal TP1 in the first mode M1, and configured to control each of the source driving chips 10 to generate the second latch signal TP2 in the second mode M2.

Specifically, in combination with the above discussion with respect to FIG. 3, it can be seen that the timing control chip can transmit the corresponding image signal RGB Data and the latch signal TP to each of the source driving chips 10. The shift register in each of the source driving chips 10 may process the image signal RGB Data to generate the initial data signal. The latch in each of the source driving chips 10 may process the initial data signal according to the latch signal TP to generate a data signal. Through the digital-to-analog converter 105 and the buffer 106, the data signal is converted into a plurality of corresponding analog data voltages (constituting the target data signal data1) acting on a plurality of sub-pixels in the panel body. The first to-be-counted signal CT acting on the counting module 101 in the first mode MI may be generated by the timing control chip. The second to-be-counted signal CK3 acting on the counting module 101 in the second mode M2 may be generated by the counting signal generating module.

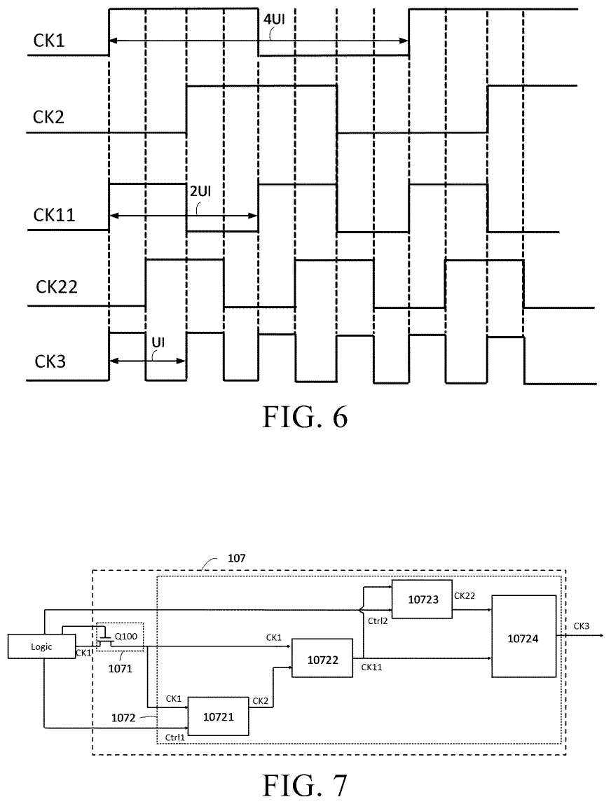

A driving method of a display panel is further provided by the present disclosure. The driving method is configured to drive the display panel. As shown in FIG. 9, the driving method can include, but is not limited to, following steps, and an order of the following steps is not limited.

At S1, the first latch signal is generated in the first mode, the first latch signal includes the first delay sub-signal, the end moment of the first delay sub-signal in the first latch signal is configured to control latching of the initial data signal, and the initial data signal is latched according to the first latch signal.

At S2, the second latch signal is generated in the second mode, the second latch signal includes the second delay sub-signal, the end moment of the second delay sub-signal in the second latch signal is configured to control latching of the initial data signal, and the initial data signal is latched according to the second latch signal.

The step S1 may include following steps:
generating the first data according to the first to-be-counted signal in the first mode; and
generating the first latch signal according to the first data.

The step S2 may include following steps:
generating the second data according to the second to-be-counted signal in the second mode; and
generating the second latch signal according to the second data.

Specifically, according to the input signal, the selecting module 108 can acquire the first to-be-counted signal configured to generate the first latch signal and control the counting module 101 to load the first latch signal to be in the first mode, or acquire the second to-be-counted signal configured to generate the second latch signal and control the counting module 101 to load the second latch signal to be in the second mode. Thus the counting module 101 may generate the first data or the second data, and in combination with the action of the logic module, the latch signal generating module is controlled to generate the first latch signal or the second latch signal according to the first data or the second data to latch the initial data signal.

In other words, the driving method may further include following steps before the step S1 and the step S2. According to an input signal, the first to-be-counted signal configured to generate the first latch signal is acquired to be in the first mode, or the second to-be-counted signal configured to generate the second latch signal is acquired to be in the second mode.

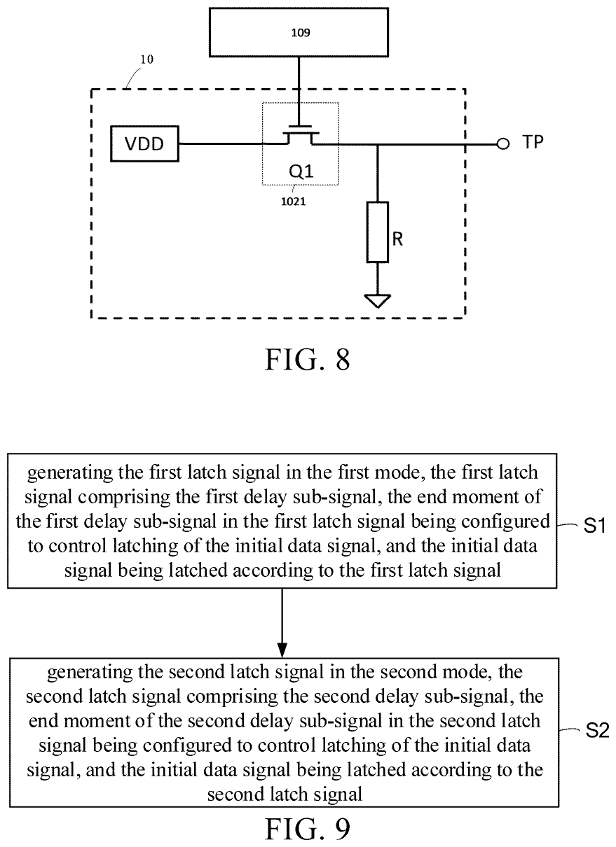

Specifically, as shown in FIG. 10, regardless of whether the display panel is in the first mode or the second mode, the driving method of the display panel may include, but is not limited to, following steps.

At S01, the first to-be-counted signal or the second to-be-counted signal is recognized.

An execution subject may be the counting module 101. It may be considered that the first to-be-counted signal is recognized in the first mode and the second to-be-counted signal is recognized in the second mode. Specific details can be found in the relevant description above.

At S02, the first data or the second data is generated.

An execution subject may be the counting module 101. It may be considered that the first data is generated according to the first to-be-counted signal or the second data is generated according to the second to-be-counted signal. Specific details can be found in the relevant description above.

At S03, it is determined whether the current first data is greater than the first threshold value or whether the second data is greater than the third threshold value.

An execution subject may be a logic module. Specific details can be found in the relevant description above.

If the current first data is greater than the first threshold value or the second data is greater than the third threshold value, following steps are executed.

At S04, a rising edge in the latch signal is generated.

An execution subject may be the latch signal generating module. The description herein is based on an example in which the amplitude of the delay sub-signal in the latch signal is less than the amplitude of the corresponding latch sub-signal. It can be understood that the end moment of the delay sub-signal (i.e., the start moment of the latch sub-signal) is reached at this point in time. Specific details can be found in the relevant description above.

At S05, a high-level state in the latch signal is maintained.

An execution subject may be the latch signal generating module. It can be understood that a latch sub-signal in the latch signal is generated and maintained at this point in time. Specific details can be found in the relevant description above.

At S06, it is determined whether the current first data is greater than the second critical value or whether the second data is greater than a fourth critical value.

An execution subject may be the logic module. It should be noted that both the first to-be-counted signal and the second to-be-counted signal are periodic signals. The logic module executes the step S02 at every moment to generate the first data or the second data corresponding to each moment, thereby the first data or the second data is updated in real time. Specific details can be found in the relevant description above.

If the current first data is greater than the second critical value or the second data is greater than a fourth critical value, a following step is executed.

At S07, a falling edge in the latch signal is generated and maintained.

An execution subject may be the latch signal generating module. It can be understood that the end moment of the latch sub-signal is reached at this moment. Meanwhile, the end moment of the latch signal is reached, and the rising edge will not be generated, thereby the falling edge is maintained. Specific details can be found in the relevant description above.

The source driving chip, the display panel, and the driving method of the display panel provided in the embodiments of the present disclosure are described in detail above. The principle and implementations of the present disclosure are described in this specification by using specific examples. The description about the foregoing embodiments is merely provided to help understand the solutions and core ideas of the present disclosure. Specific details can be found in the relevant description above. Persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A source driving chip, having a first mode and a second mode, the source driving chip comprising:
a counting module configured to generate a first data according to a first to-be-counted signal in the first mode and generate a second data according to a second to-be-counted signal in the second mode; and
a latch signal generating module electrically connected to the counting module, wherein the latch signal generating module is configured to generate a first latch signal according to the first data in the first mode and generate a second latch signal according to the second data in the second mode;
wherein the first latch signal comprises a first delay sub-signal, the second latch signal comprises a second delay sub-signal, an end moment of the first delay sub-signal in the first latch signal is configured to control latching of an initial data signal, an end moment of the second delay sub-signal in the second latch signal is configured to control latching of the initial data signal, and the end moment of the second delay sub-signal is earlier than the end moment of the first delay sub-signal.

2. The source driving chip according to claim 1, wherein the first to-be-counted signal and the second to-be-counted signal are both periodic signals, and a period of the second to-be-counted signal is smaller than a period of the first to-be-counted signal.

3. The source driving chip according to claim 2, wherein the counting module is configured to count once at each rising edge of the first to-be-counted signal, and the first data is equal to a number of times currently counted; and
wherein the counting module is further configured to count once at each rising edge of the second to-be-counted signal, and the second data is equal to a number of times currently counted.

4. The source driving chip according to claim 1, further comprising:
a to-be-counted signal generating module electrically connected to the counting module and configured to generate the second to-be-counted signal;
wherein the to-be-counted signal generating module is configured to generate the second to-be-counted signal according to an initial to-be-counted signal or the first to-be-counted signal, the initial to-be-counted signal, the first to-be-counted signal, and the second to-be-counted signal are all periodic signals, and a period of the initial to-be-counted signal is smaller than the period of the first to-be-counted signal.

5. The source driving chip according to claim 3, wherein the to-be-counted signal generating module comprises a first switching unit, and a raising-frequency unit electrically connected, wherein the raising-frequency unit is electrically connected to the counting module;
wherein the first switching unit is configured to control the initial to-be-counted signal or the first to-be-counted signal to be transmitted to the raising-frequency unit according to a first switching signal in the second mode; and
wherein the raising-frequency unit is configured to generate the second to-be-counted signal according to the initial to-be-counted signal or the first to-be-counted signal in the second mode.

6. The source driving chip according to claim 4, wherein the raising-frequency unit comprises:
a first delay sub-unit electrically connected to the first switching unit, wherein the first delay sub-unit is configured to generate a first transition signal according to a first control signal and one of the initial to-be-counted signal and the first to-be-counted signal in the second mode, the first transition signal is a signal acquired by the first to-be-counted signal being delayed for a first preset period, and the first preset period is not equal to 0; and
a first exclusive-OR sub-unit electrically connected to the first delay sub-unit and the first switching unit, wherein the first exclusive-OR sub-unit is configured to generate the second to-be-counted signal or a second transition signal according to the first transition signal and one of the initial to-be-counted signal and the first to-be-counted signal in the second mode, the second transition signal is configured to generate the second to-be-counted signal, the second to-be-counted signal or the second transition signal generated by the first exclusive-OR sub-unit is a signal acquired by the first transition signal and one of the initial to-be-counted signal and the first to-be-counted signal being performed an exclusive-OR operation, and a period of one of the second to-be-counted signal and the second transition signal generated by the first exclusive-OR sub-unit is half of a period of one of the initial to-be-counted signal and the first to-be-counted signal.

7. The source driving chip according to claim 6, wherein the first exclusive-OR sub-unit is configured to generate the second transition signal, and the raising-frequency unit further comprises:
a second delay sub-unit electrically connected to the first exclusive-OR sub-unit, wherein the second delay sub-unit is configured to generate a third transition signal according to the second transition signal and a second control signal in the second mode, the third transition signal is a signal acquired by the second transition signal being delayed for a second preset period, and the second preset period is not equal to 0; and
a second exclusive-OR sub-unit electrically connected to the second delay sub-unit and the first exclusive-OR sub-unit, wherein the second exclusive-OR sub-unit is configured to generate the second to-be-counted signal according to the third transition signal and the second transition signal, the second to-be-counted signal generated by the first exclusive-OR sub-unit is a signal acquired by the third transition signal and the second transition signal being performed an exclusive-OR operation, and a period of the second to-be-counted signal generated by the second exclusive-OR sub-unit is half of a period of the second transition signal.

8. The source driving chip according to claim 3, further comprising:
a selecting module electrically connected to the counting module, wherein the selecting module is configured to control the counting module to load the first to-be-counted signal to be in the first mode or control the counting module to load the second to-be-counted signal to be in the second mode according to an input signal.

9. The source driving chip according to claim 1, further comprising:
a logic module electrically connected between the counting module and the latch signal generating module, wherein the logic module is configured to generate a first determination data according to the first data in the first mode and generate a second determination data according to the second data in the second mode;
wherein the latch signal generating module comprises:
a second switching unit electrically connected to the logic module, wherein the second switching unit is configured to control the end moment of the first delay sub-signal in the first latch signal according to the first determination data in the first mode, and control the end moment of the second delay sub-signal in the second latch signal according to the second determination data in the second mode.

10. A display panel, comprising a panel body and a driving chip electrically connected to the panel body, wherein the driving chip comprises:
at least two source driving chips each having a first mode and a second mode, the source driving chip comprising:
a counting module configured to generate a first data according to a first to-be-counted signal in the first mode and generate a second data according to a second to-be-counted signal in the second mode; and
a latch signal generating module electrically connected to the counting module, wherein the latch signal generating module is configured to generate a first latch signal according to the first data in the first mode and generate a second latch signal according to the second data in the second mode;
wherein the first latch signal comprises a first delay sub-signal, the second latch signal comprises a second delay sub-signal, an end moment of the first delay sub-signal in the first latch signal is configured to control latching of an initial data signal, an end moment of the second delay sub-signal in the second latch signal is configured to control latching of the initial data signal, the end moment of the second delay sub-signal is earlier than the end moment of the first delay sub-signal, and each of the source driving chips is configured to generate a target data signal according to the initial data signal and transmit the target data signal to the panel body; and
a timing control chip electrically connected to the source driving chips, wherein the timing control chip is configured to control each of the source driving chips to generate the first latch signal in the first mode, and configured to control each of the source driving chips to generate the second latch signal in the second mode.

11. The display panel according to claim 10, wherein the first to-be-counted signal and the second to-be-counted signal are both periodic signals, and a period of the second to-be-counted signal is smaller than a period of the first to-be-counted signal.

12. The display panel according to claim 11, wherein the counting module is configured to count once at each rising edge of the first to-be-counted signal, and the first data is equal to a number of times currently counted; and
wherein the counting module is further configured to count once at each rising edge of the second to-be-counted signal, and the second data is equal to a number of times currently counted.

13. The display panel according to claim 10, wherein each of the source driving chips comprises:
a to-be-counted signal generating module electrically connected to the counting module and configured to generate the second to-be-counted signal;
wherein the to-be-counted signal generating module is configured to generate the second to-be-counted signal according to an initial to-be-counted signal or the first to-be-counted signal, the initial to-be-counted signal, the first to-be-counted signal, and the second to-be-counted signal are all periodic signals, and a period of the initial to-be-counted signal is smaller than the period of the first to-be-counted signal.

14. The display panel according to claim 12, wherein the to-be-counted signal generating module comprises a first switching unit, and a raising-frequency unit electrically connected, wherein the raising-frequency unit is electrically connected to the counting module;
wherein the first switching unit is configured to control the initial to-be-counted signal or the first to-be-counted signal to be transmitted to the raising-frequency unit according to a first switching signal in the second mode; and
wherein the raising-frequency unit is configured to generate the second to-be-counted signal according to the initial to-be-counted signal or the first to-be-counted signal in the second mode.

15. The display panel according to claim 13, wherein the raising-frequency unit comprises:
a first delay sub-unit electrically connected to the first switching unit, wherein the first delay sub-unit is configured to generate a first transition signal according to a first control signal and one of the initial to-be-counted signal and the first to-be-counted signal in the second mode, the first transition signal is a signal acquired by the first to-be-counted signal being delayed for a first preset period, and the first preset period is not equal to 0; and
a first exclusive-OR sub-unit electrically connected to the first delay sub-unit and the first switching unit, wherein the first exclusive-OR sub-unit is configured to generate the second to-be-counted signal or a second transition signal according to the first transition signal and one of the initial to-be-counted signal and the first to-be-counted signal in the second mode, the second transition signal is configured to generate the second to-be-counted signal, the second to-be-counted signal or the second transition signal generated by the first exclusive-OR sub-unit is a signal acquired by the first transition signal and one of the initial to-be-counted signal and the first to-be-counted signal being performed an exclusive-OR operation, and a period of one of the second to-be-counted signal or the second transition signal generated by the first exclusive-OR sub-unit is half of a period of one of the initial to-be-counted signal and the first to-be-counted signal.

16. The display panel according to claim 15, wherein the first exclusive-OR sub-unit is configured to generate the second transition signal, and the raising-frequency unit further comprises:
a second delay sub-unit electrically connected to the first exclusive-OR sub-unit, wherein the second delay sub-unit is configured to generate a third transition signal according to the second transition signal and a second control signal in the second mode, the third transition signal is a signal acquired by the second transition signal being delayed for a second preset period, and the second preset period is not equal to 0; and
a second exclusive-OR sub-unit electrically connected to the second delay sub-unit and the first exclusive-OR sub-unit, wherein the second exclusive-OR sub-unit is configured to generate the second to-be-counted signal according to the third transition signal and the second transition signal, the second to-be-counted signal generated by the first exclusive-OR sub-unit is a signal acquired by the third transition signal and the second transition signal being performed an exclusive-OR operation, and a period of the second to-be-counted signal generated by the second exclusive-OR sub-unit is half of a period of the second transition signal.

17. The display panel according to claim 12, wherein each of the source driving chips comprises:
a selecting module electrically connected to the counting module, wherein the selecting module is configured to control the counting module to load the first to-be-counted signal to be in the first mode or control the counting module to load the second to-be-counted signal to be in the second mode according to an input signal.

18. The display panel according to claim 10, wherein each of the source driving chips comprises:
a logic module electrically connected between the counting module and the latch signal generating module, wherein the logic module is configured to generate a first determination data according to the first data in the first mode and a second determination data according to the second data in the second mode;
wherein the latch signal generating module comprises:
a second switching unit electrically connected to the logic module, wherein the second switching unit is configured to control the end moment of the first delay sub-signal in the first latch signal according to the first determination data in the first mode, and control the end moment of the second delay sub-signal in the second latch signal according to the second determination data in the second mode.

19. A driving method of a display panel, configured to drive the display panel, wherein the display panel comprises a panel body and a driving chip electrically connected to the panel body, and the driving chip comprises:
at least two source driving chips each having a first mode and a second mode, wherein the source driving chip comprises:
a counting module configured to generate a first data according to a first to-be-counted signal in the first mode and generate a second data according to a second to-be-counted signal in the second mode; and
a latch signal generating module electrically connected to the counting module, wherein the latch signal generating module is configured to generate a first latch signal according to the first data in the first mode and generate a second latch signal according to the second data in the second mode;
wherein the first latch signal comprises a first delay sub-signal, the second latch signal comprises a second delay sub-signal, an end moment of the first delay sub-signal in the first latch signal is configured to control latching of an initial data signal, an end moment of the second delay sub-signal in the second latch signal is configured to control latching of the initial data signal, the end moment of the second delay sub-signal is earlier than the end moment of the first delay sub-signal, wherein and each of the source driving chips is configured to generate a target data signal according to the initial data signal and transmit the target data signal to the panel body; and
a timing control chip electrically connected to the source driving chips, wherein the timing control chip is configured to control each of the source driving chips to generate the first latch signal in the first mode, and configured to control each of the source driving chips to generate the second latch signal in the second mode;
the driving method further comprising steps of:
generating the first latch signal in the first mode, and the initial data signal being latched according to the first latch signal; and
generating the second latch signal in the second mode, the second latch signal comprising the second delay sub-signal, and the initial data signal being latched according to the second latch signal;
wherein the step of generating the first latch signal in the first mode comprises:
generating the first data according to the first to-be-counted signal in the first mode; and
generating the first latch signal according to the first data; and
wherein the step of generating the second latch signal in the first mode comprises:
generating the second data according to the second to-be-counted signal in the second mode; and
generating the second latch signal according to the second data.

20. The driving method of the display panel according to claim 19, further comprising:
according to an input signal, acquiring the first to-be-counted signal configured to generate the first latch signal to be in the first mode, or acquiring the second to-be-counted signal configured to generate the second latch signal to be in the second mode.
